(19) United States
(12) Patent Application Publication
(10) Pub. No.: US 2016/0316373 A1
(43) Pub. Date: Oct. 27, 2016

(54) TECHNIQUES FOR MANAGING SECURITY MODE COMMAND (SMC) INTEGRITY FAILURES AT A USER EQUIPMENT (UE)

(71) Applicant: QUALCOMM Incorporated, San Diego, CA (US)

(72) Inventors: Vagish Gupta, Hyderabad (IN); Liangchi HSU, San Diego, CA (US); Ansah Ahmed Sheik, Eluru (IN); Dominique Francois Bressanelli, Frankfurt (DE)

(21) Appl. No.: 14/997,414

(22) Filed: Jan. 15, 2016

Related U.S. Application Data
(60) Provisional application No. 62/153,375, filed on Apr. 27, 2015.

(51) Int. Cl. H04W 12/10; H04W 12/04; H04L 9/08; H04W 12/06; H04W 48/04

(52) U.S. Cl. CPC H04W 12/10; H04W 12/06; H04W 48/04; H04L 9/0891; H04W 12/04

(57) ABSTRACT

The present disclosure describes a method and an apparatus for managing security mode command (SMC) integrity failures at a user equipment (UE). For example, a method is provided for managing SMC integrity failures which receives a SMC message at the UE from a network entity. A message authentication code for data integrity (MAC-I) failure based at least on a mismatch of a security parameter at the UE may be detected at the UE. Moreover, a corrective action may be performed at the UE in response to the detection of the MAC-I failure at the UE.

### CLAIM OF PRIORITY

The present application for patent claims priority to U.S. Provisional Patent Application No. 62/153,375, filed Apr. 27, 2015, entitled “Techniques for Handling Security Mode Command (SMC) Integrity Failure,” which is assigned to the assignee hereof, and hereby expressly incorporated by reference herein.

### BACKGROUND

The present disclosure relates generally to communication systems, and more particularly, to performance of a user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

When a UE receives a security mode command (SMC) message from a network entity (e.g., radio network controller, RNC), the UE may perform a message authentication code for data integrity (MAC-I) on the SMC message. If the SMC message fails to pass the MAC-I, the UE may ignore the SMC message without sending a response to the network entity. As a result, the network entity may consider the UE as a rogue UE about 2-4 seconds from the time the SMC message was transmitted from the network entity to the UE may power off (or stop transmitting) dedicated channel (DCH) to the UE. This may lead to a radio link failure (RLF) at the UE and the UE may perform a cell update procedure resulting in a call drop at the UE.

Thus, there is a desire for a method and an apparatus for managing SMC integrity failures at a UE.

### BRIEF DESCRIPTION OF THE DRAWINGS

FIG. 1 is a schematic diagram of a wireless communications system including a user equipment having an aspect of a security mode command (SMC) integrity function for managing SMC integrity failures at the user equipment.

FIG. 2 illustrates an example message flow diagram for authenticating data integrity of a signaling message in aspects of the present disclosure.

FIG. 3 illustrates an example message flow diagram illustrating SMC integrity failure at a user equipment.

FIG. 4 illustrates an example message flow diagram for managing SMC integrity failures at a user equipment in aspects of the present disclosure.

FIG. 5 illustrates an example methodology for managing SMC integrity failures at a user equipment in aspects of the present disclosure.

FIG. 6 is a block diagram illustrating aspects of an example user equipment including a SMC integrity function according to the present disclosure.

FIG. 7 is a block diagram conceptually illustrating an example of a telecommunications system including a user equipment with a SMC integrity function according to the present disclosure.

FIG. 8 is a conceptual diagram illustrating an example of an access network including a user equipment with a SMC integrity function according to the present disclosure.

FIG. 9 is a conceptual diagram illustrating an example of a radio protocol architecture for the user and control plane that may be used by the user equipment of the present disclosure.

FIG. 10 is a block diagram conceptually illustrating an example of a Node B in communication with a UE, which includes a SMC integrity function according to the present disclosure, in a telecommunications system.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and apparatus for managing security mode command (SMC) integrity failures at a UE. For example, the present disclosure presents an example method for managing security mode command (SMC) integrity failures at a user equipment (UE) which may include receiving a SMC message at the UE from a network entity, detecting a message authentication code for data integrity (MAC-I) failure based at least on a mismatch of a security parameter at the UE, and performing a corrective action at the UE in response to detecting the MAC-I failure at the UE.

Further, the present disclosure provides an apparatus for managing SMC integrity failures at a UE that may include means for receiving a SMC message at the UE from a network entity, means for detecting a message authentication code for data integrity (MAC-I) failure based at least on a mismatch of a security parameter at the UE, and means for performing a corrective action at the UE in response to detecting the MAC-I failure at the UE.

Furthermore, the present disclosure provides an apparatus for managing SMC integrity failures at a UE that may include a memory configured to store data; and one or more processors communicatively coupled with the memory, wherein the one or more processors and the memory are configured to receive a SMC message at the UE from a network entity, detect a message authentication code for data integrity (MAC-I) failure based at least on a mismatch of a security parameter at the UE, and perform a corrective action at the UE in response to detecting the MAC-I failure at the UE.

Additionally, the present disclosure provides a non-transitory computer readable medium storing computer executable code for managing SMC integrity failures at a UE that may include code for receiving a SMC message at the UE from a network entity, code for detecting a message authentication code for data integrity (MAC-I) failure based at least on a mismatch of a security parameter at the UE, and code for performing a corrective action at the UE in response to detecting the MAC-I failure at the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides an example method and an apparatus for managing security mode command (SMC) integrity failures at a user equipment (UE). The method and apparatus may include receiving a SMC message at the UE from a network entity, detecting a message authentication code for data integrity (MAC-I) failure based at least on a mismatch of a security parameter at the UE, and performing a corrective action at the UE in response to detecting the MAC-I failure at the UE.

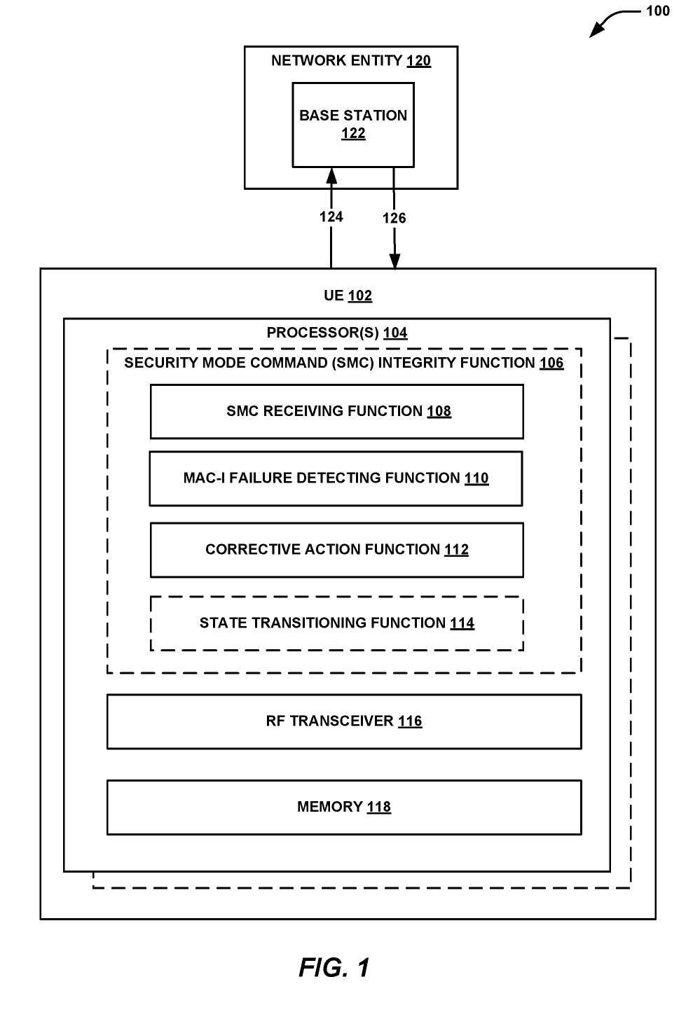

Referring to FIG. 1, in an aspect, a wireless communication system 100 includes a user equipment (UE) 102 in communication with a network entity 120 and/or base station 122, one or more processors 104, and a security mode command (SMC) integrity function 106 running on processor 104 (or processors 104 in a distributed computing environment) for managing SMC integrity failures at the UE.

UE 102 may communicate with network entity 120 which may include one or more base stations 122 via one or more over-the-air links, e.g., an uplink (UL) 124 and/or a downlink (DL) 126. In an aspect, UL 124 is generally used for communication from UE 102 to network entity 120 and/or base station 122 and DL 126 is generally used for communication from network entity 120 and/or base station 122 to UE 102. In an additional aspect, network entity 120 may include a radio network controller (RNC) and/or mobile management entity (MME), not shown in FIG. 1.

In an aspect, network entity 120 may include, but not limited to, an access point, a base station (BS) or Node B or eNodeB, a macro cell, a small cell (e.g., a femtocell, or a pico cell), a relay, a peer-to-peer device, an authentication, authorization and accounting (AAA) server, a mobile switching center (MSC), Mobility Management Entity (MME), SON management server, OAM server, Home NodeB Management System (HMS), Home eNodeB Management System (HeMS), etc. Additionally, network entity 120 may include one or more of any type of network components that can enable base station 122 communicate and/or establish and maintain links 124 and/or 126 with UE 102. In an example aspect, base station 122 may operate according to Wideband Code Division Multiple Access (W-CDMA), Code Division Multiple Access (CDMA), Time Division Synchronous Code Division Multiple Access (TD-SCDMA), Long Term Evolution (LTE), or Global System for Mobile Communications (GSM) standard as defined in 3GPP Specifications.

In an aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, SMC integrity function 106 may be configured to transmit/receive messages to/from network entity 120 via one or more radio frequency (RF) transceiver(s) 116. For example, SMC integrity function 106 may include and execute communication protocols and/or manage other standards-specific communication procedures using protocols and/or standards-specific instructions and/or subscription-specific configuration information that allow communications with network entity 120 and/or UE 102. Further, RF transceiver 116 may be configured to transmit and/or receive the communication exchange signaling to and/or from one or more base stations 122 or other devices in wireless communication system 100. For example, RF transceiver 116 may include, but is not limited to, one or more of a transmitter, a receiver, a transceiver, protocol stacks, transmit chain components, and/or receive chain components. Additionally, UE 102 may include memory 118.

In an aspect, UE 102 may include SMC integrity function 106 for managing SMC integrity failures at UE 102 by receiving a SMC message at the UE from network entity 120, detecting a message authentication code for data integrity (MAC-0 failure based at least a mismatch of a security parameter at UE 102, and performing a corrective action at UE 102 in response to detecting the MAC-I failure at the UE.

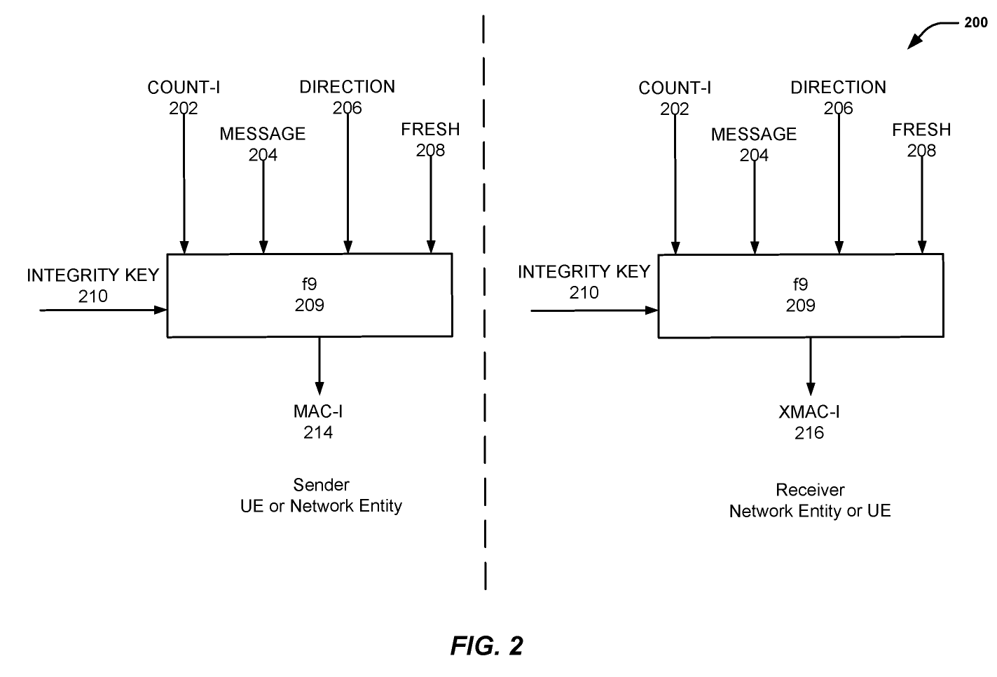

FIG. 2 illustrates an example methodology 200 to authenticate data integrity of a signaling message.

For instance, in an aspect, FIG. 2 illustrates an example use of integrity algorithm to authenticate the data integrity of a signaling message. In an aspect, the input parameters to the algorithm are integrity key (IK) 210, integrity sequence number (COUNT-I) 202, a random value generated by network entity (FRESH) 208, direction bit (DIRECTION) 206, and signaling data (MESSAGE) 204. In an aspect, based on these input parameters, a user (e.g., UE or network entity) computes message authentication code for data integrity (MAC-I) using the integrity algorithm f9. The MAC-I is then appended to the message sent over the radio access link (e.g., from UE to network entity or network entity to UE). The receiver then computes XMAC-I on the received message in a similar way as the sender computed MAC-I on the message sent and verifies the data integrity of the message by comparing it to the received MAC-I.

In an aspect, COUNT-I 202 may be composed of two parts, a “short” sequence number and a “long” sequence number. The short sequences number is a 4-bit RRC sequence number (RRC SN) that is available in each RRC PDU and forms the lease significant bits of COUNT-I. The long sequence number is a 28-bit RRC hyper frame number (RRC HFN) which is incremented at each RRC SN cycle and forms the most significant bits of COUNT-I.

In an aspect, IK 210 is 128 bits long. There may be one IK for circuit switched (CS) connections (IKCS) established between CS service domain and the user and another IK for packet switched (PS) connections (IKPS) established between PS service domain and the user. The IK is stored in the USIM and a copy is stored in the UE. IK is sent from the USIM to the UE upon request of the UE and when a valid IK is available. Additionally, the UE triggers a new authentication procedure if the current value of STARTCS or STARTPS in the USIM are not up-to-date or STARTCS or STARTPS have reached THRESHOLD. The UE deletes IK from memory after power- off as well as after removal of the USIM.

IK is sent from VLR/SGSN to the RNC in the (RANAP) security mode command. At handover, the IK is transmitted within the network infrastructure from the old RNC to the new RNC, to enable the communication to proceed, and the synchronization procedure is resumed. The IK remains unchanged at handover, with the exception of SRVCC handover and reverse SRVCC handover.

In an aspect, the network-side nonce (e.g., FRESH parameter) 206 is 32 bits long. There is one FRESH parameter value per user. The input FRESH parameter protects the network against replay of signaling messages by the user (UE). At connection set-up, network entity (e.g., RNC) generates a random value FRESH and sends it to the user (e.g., UE) in the (RRC) security mode command. The value (FRESH) is subsequently used by both the network and the user (UE) throughout the duration of a single connection. This mechanism assures the network that the user is not replaying any old MAC-Is. At handover with relocation of the S-RNC, the new S-RNC generates its own value for the FRESH parameter and sends it to the UE in the RRC message that indicates a new UTRAN Radio Network Temporary Identity due to SRNC relocation.

In an aspect, direction identifier DIRECTION 206 is 1 bit long. The direction identifier is input to avoid that the integrity algorithm used to compute the message authentication codes would use an identical set of input parameter values for the up-link and for the down-link messages. The value of DIRECTION 206 is “0” for messages from UE to network entity (e.g., RNC) and “1” for messages from network entity to UE.

In an aspect, MESSAGE 204 includes the signaling message itself with the radio bearer identity. The radio bearer identity is appended in front of the message. Note that the radio bearer identity is not transmitted with the message but it is needed to avoid that for different instances of message authentication codes the same set of input parameters is used.

In an aspect, there may be one IK 210 for CS connections (IKCS) established between the CS service domain and the user and another IK for PS connections (IKPS) established between the PS service domain and the user. The data integrity of radio bearers for user data is not protected. The signaling radio bearers are used for transfer of signaling data for services delivered by both CS and PS service domains. These signaling radio bearers are data integrity protected by the IK of the service domain for which the most recent security mode negotiation took place. This may require that the integrity key of an (already integrity protected) ongoing signaling connection has to be changed, when a new connection is established with another service domain, or when a security mode negotiation follow a re-authentication during an ongoing connection. This change should be completed by the RNC within five seconds after receiving the security mode command from the VLR/SGSN.

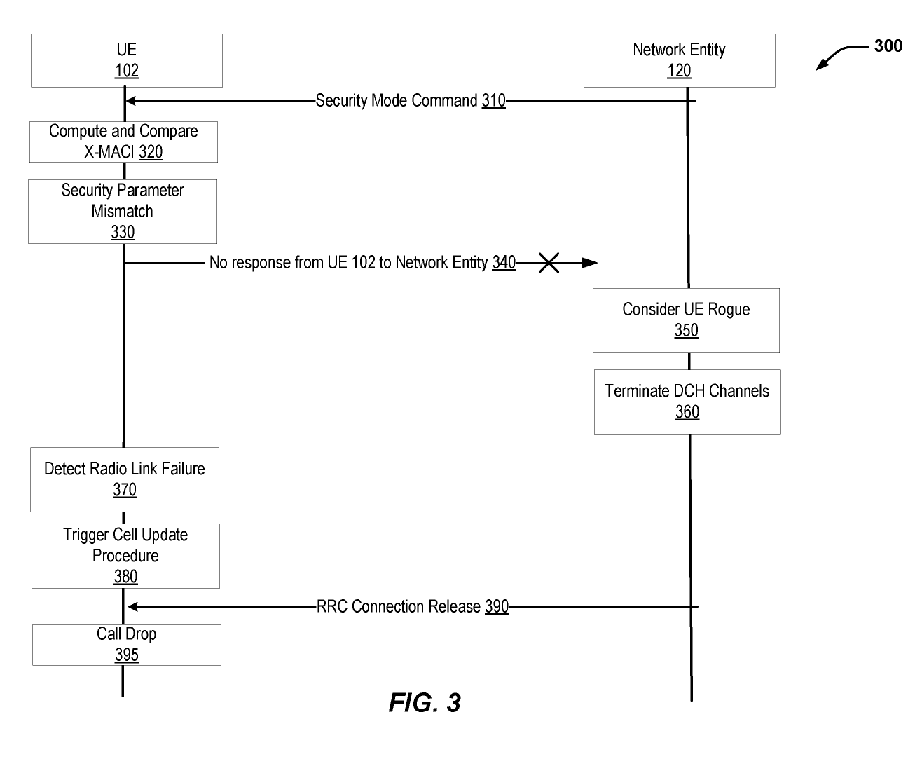

FIG. 3 illustrates an example message flow diagram 300 illustrating SMC integrity failure at a UE.

At block 310, network entity 120 generates a SMC message, a radio resource control (RRC) message. In an aspect, for example, the SMC message may include UE security capability, UMTS integrity algorithm (UIA), FRESH parameter value, and/or UMTS encryption algorithm to be used. Additionally, as the UE may have two ciphering and integrity key sets, network entity 120 may indicate which key set to use. This may be obtained by including a CN type indicator information in the SMC message. In an aspect, prior to sending the SMC message to UE 102, network entity 120 may generate a MAC-I (Message Authentication Code for Integrity) as described above in reference to FIG. 2 and append (e.g., attach) the MAC-I to the SMC message.

At block 320, UE 102 receives the SMC message and computes XMAC-I, as described in detail in reference to FIG. 2. For instance, UE 102 computes XMAC-I on the message received from network entity 120 by using the indicated UIA, COUNT-I generated from the stored START and the received FRESH parameter. Additionally, the UE verifies the integrity of the received SMC message by comparing the received MAC-I with the generated XMAC-I.

At block 330, UE 102 may detect a mismatch of a security parameter when the received MAC-I does not match with the generated XMAC-I based on the comparison at block 320.

At block 340, this may result in UE 102 not sending a response to the SMC message received from network entity at block 310. Additionally, at block 340, a timer (e.g., configured to a value of 2-4 seconds) at network entity 120 which may have been initiated when the network entity sent a SMC message to the UE may expire.

At block 350, network entity 120 may consider the UE as a “rogue” UE upon expiration of the timer. For instance, a UE may be considered as a rogue UE by the network entity when the network entity considers the UE to be different from the UE that was authenticated in a previous authentication process, the UE may be authenticated but the integrity key is corrupt at the UE, or an intruder intercepted the SMC message from the network entity to the UE and corrupted the communication path.

At block 360, network entity 120 may power-off (e.g., terminate, stop transmitting, etc.) dedicated channel (DCH) for the UE after considering the UE as a rogue UE. At block 370, UE 102 may detect a radio link failure (RLC). This may be due the powering-off of DCH by network entity 120.

At block 380, UE 102 may trigger a cell update procedure once the DCH for UE 102 are turned off. At block 390, network entity 120 may send a RRC connection release message to the UE.

At block 395, this may result in a call drop at UE 102, especially if the call is a CS call. Such call failures may continue until a new authentication of the UE is performed by the network entity before a SMC with CS domain is sent to the UE. In an additional or optional aspect, network entity 120 may send a RRC connection release after a wait timer for the SMC message (a timer initiated upon sending a SMC message to the UE at block 310) expires which may also result in a CS call drop.

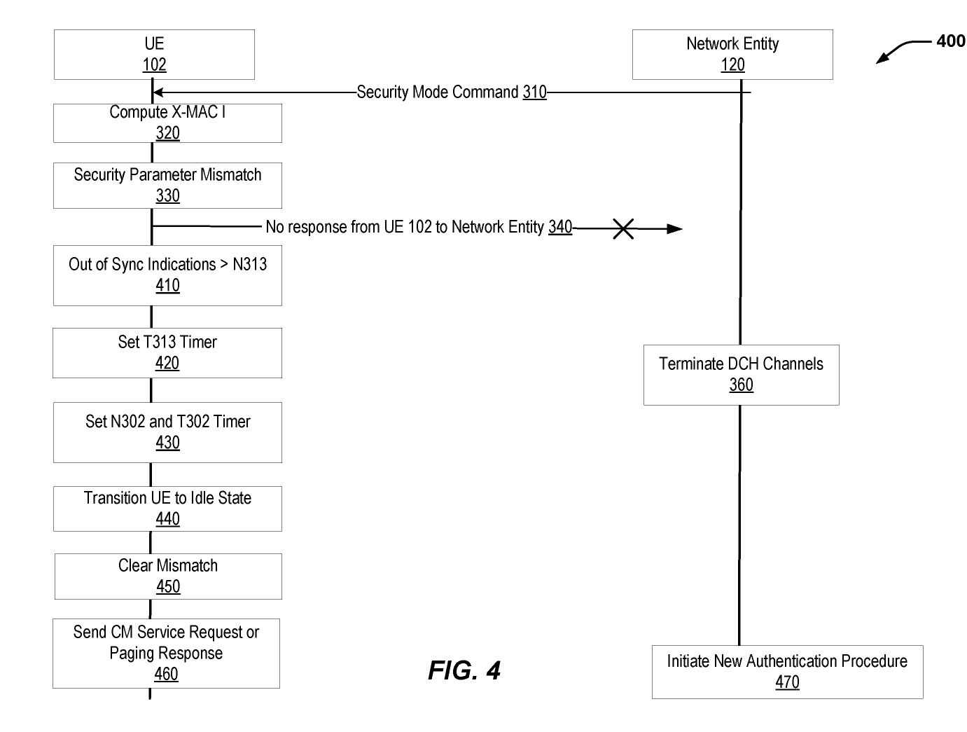

FIG. 4 illustrates an example message flow diagram 400 for managing security mode command (SMC) integrity failures at a UE.

The messages transmitted or received at blocks 310, 320, 330, and 340 are also illustrated in FIG. 4 for completeness. The related description of these messages transmitted/received at these blocks described above in reference to FIG. 3 is also applicable to FIG. 4.

At block 410, UE 102 detects that the number of consecutive out of sync indications from L1 of the UE is above a maximum value, e.g., N313 parameter. In an aspect, N313 may be set to a value of 1, 2, 4, 10, 20, 50, 100, and/or 200. For instance, in an aspect, for managing SMC integrity failures at the UE, N313 may be set to a low value, e.g., 1, 2, 4, 10, etc. At block 420, UE 102 may set a timer, e.g., T313 timer to a small value, e.g., 0, 1, 2, 3, etc in response to detecting that the number of consecutive out of sync indications from the L1 of the UE is above the maximum value. This allows the UE to detect the RLF at the UE earlier.

At block 430, UE 102 may set N302 parameter and T302 timer to smaller values that so that the cell update procedure is skipped at the UE. For instance, UE 102 may set N302 parameter and T302 timer to zero values to skip the cell update procedure at the UE. At block 440, UE 102 may transition to idle state as there is no use for the UE to be in (or enter) connected state without resolving authentication key mismatch at the UE.

At block 450, UE 102 may clear the mismatch. For example, in an aspect, UE 102 may clear the mis-matched security parameters (e.g., authentication key). Once the security parameters are cleared at block 450, in an aspect, at block 460 UE 102 may send the next layer 3 (L3) message, e.g., a configuration message (CM) service request for mobile originated (MO) calls or a paging response to mobile terminated (MT) calls, to the network entity. The L3 message may be transmitted from the UE to the network entity with the CKSN set to a value of 7 for triggering a new authentication procedure at the network entity. In an additional or optional aspect, a MO call at the UE may be silently re-tried (e.g., UE re-attempts the call without informing a call initiator) when the MO call failed due radio resource control (RRC) connection drop. For instance, in aspect, the RRC connection drop may be associated with the SMC integrity failure at the UE.

As such, SMC integrity failures at a UE may be managed by clearing up the mismatch in a timely manner and initiating new authentication procedures to authenticate data integrity of a signaling message.

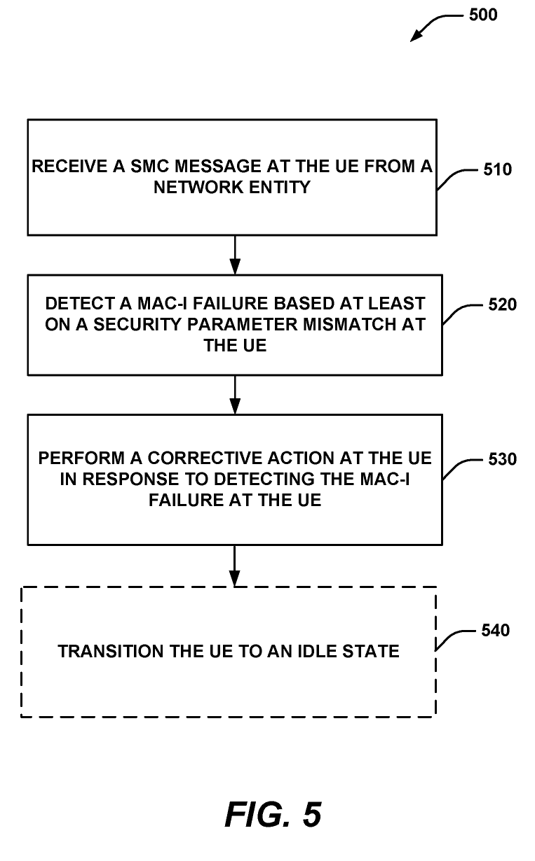

FIG. 5 illustrates an example methodology 500 for managing security mode command (SMC) integrity failures at a user equipment (UE).

In an aspect, at block 510, methodology 500 may include receiving a SMC message at the UE from a network entity. For example, in an aspect, UE 102, RF transceiver 116, and/or SMC integrity function 106 may include a specially programmed processor module, or a processor executing specially programmed code stored in a memory, to receive a SMC message at UE 102 from network entity 120.

For example, in an aspect, UE 102 may receive a SMC message from network entity 120 (e.g., RNC). The SMC message contains an ordered list of allowed UIAs in order of preference, and the IK to be used. If ciphering is started, it contains the ordered list of allowed UEAs in order of preference, and the CK to be used. In an aspect, SMC integrity function 106 may include a SMC receiving function 108 to perform this functionality.

In an aspect, at block 520, methodology 500 may include detecting a message authentication code for data integrity (MAC-I) failure based at least a mismatch of a security parameter at the UE. For example, in an aspect, UE 102, RF transceiver 116, and/or SMC integrity function 106 may include a specially programmed processor module, or a processor executing specially programmed code stored in a memory, to detect a MAC-I failure based at least on a mismatch of a security parameter at the UE. For instance, UE 102 may compute the X-MACI and compare with the MAC-I received from the network entity for detecting a mismatch of a security parameter (e.g., integrity key). In an aspect, SMC integrity function 106 may include a MAC-I failure detecting function 110 to perform this functionality.

In an aspect, at block 530, methodology 500 may include performing a corrective action at the UE in response to detecting the MAC-I failure at the UE. For example, in an aspect, UE 102, RF transceiver 116, and/or SMC integrity function 106 may include a specially programmed processor module, or a processor executing specially programmed code stored in a memory, to perform a corrective action at UE 102 in response to detecting the MAC-I failure at the UE. For instance, in an aspect, UE 102 may identify that consecutive out of sync indications from layer 1 (L1) of the UE is above a N313 parameter value and set a T313 timer at the UE to a smaller value in response to identifying that consecutive out of sync indications from the L1 of the UE is above the N313 parameter value. In an aspect, SMC integrity function 106 may include a corrective action function 112 to perform this functionality.

Optionally, in an aspect, at block 540, methodology 500 may include transitioning the UE to an idle state after setting the N302 parameter and the T302 timer to the zero values. For example, in an aspect, UE 102, RF transceiver 116, and/or SMC integrity function 106 may include a specially programmed processor module, or a processor executing specially programmed code stored in a memory, to transition the UE to an idle state after setting the N302 parameter and the T302 timer to the zero values. In an aspect, SMC integrity function 106 may optionally include a state transitioning function 114 to perform this functionality.

As such, SMC integrity failures at a UE may be managed by receiving a SMC message at the UE from a network entity, detecting a message authentication code for data integrity (MAC-I) failure based at least on a security parameter mismatch at the UE, and performing a corrective action at the UE in response to detecting the MAC-I failure at the UE.

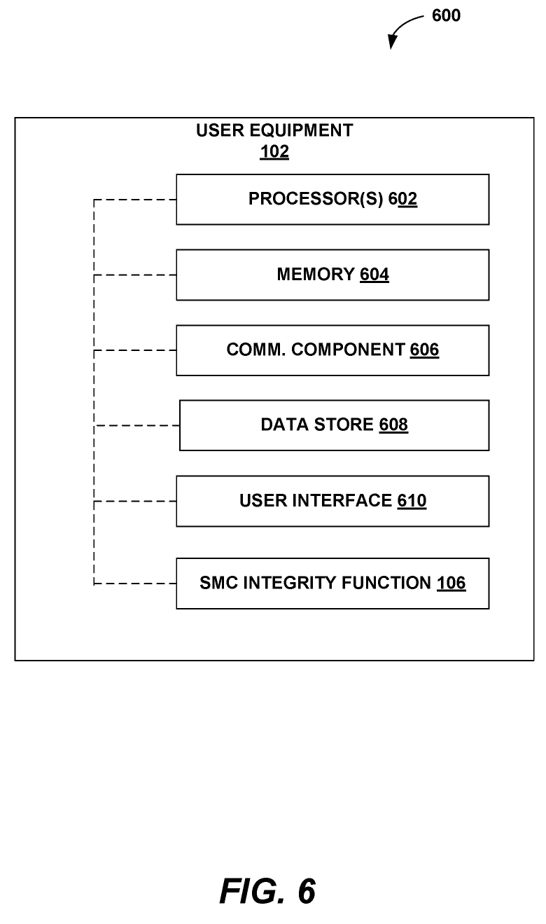

Referring to FIG. 6, in an aspect, UE 102, for example, including SMC integrity function 106, may be or may include a specially programmed or configured computer device to perform the functions described herein. In one aspect of implementation, UE 102 may include SMC integrity function 106, SMC receiving function 108, MAC-I failure detecting function 110, corrective action function 112, and/or a state transitioning function 114, such as in specially programmed computer readable instructions or code, firmware, hardware, or some combination thereof.

In an aspect, for example as represented by the dashed lines, SMC integrity function 106 may be implemented in or executed using one or any combination of processor 602 (e.g., processor 104 of FIG. 1), memory 604, communications component 606, and data store 608. For example, SMC integrity function 106 may be executed on one or more processors 104. Further, for example, SMC integrity function 106 may be defined as a computer-readable medium stored in memory 604 and/or data store 608 and executed by processor 104. Moreover, for example, inputs and outputs relating to operations of SMC integrity function 106 may be provided or supported by communications component 606, which may provide a bus between the components of computer device 600 or an interface for communication with external devices or components.

UE 102 may include processor 104 specially configured to carry out processing functions associated with one or more of components and functions described herein. Processor 104 can include a single or multiple set of processors or multi-core processors. Moreover, processor 104 can be implemented as an integrated processing system and/or a distributed processing system.

User equipment 102 further includes memory 604, such as for storing data used herein and/or local versions of applications and/or instructions or code being executed by processor 104, such as to perform the respective functions of the respective entities described herein. Memory 604 can include any type of memory usable by a computer, such as random access memory (RAM), read only memory (ROM), tapes, magnetic discs, optical discs, volatile memory, non-volatile memory, and any combination thereof.

Further, user equipment 102 includes communications component 606 that provides for establishing and maintaining communications with one or more parties utilizing hardware, software, and services as described herein. Communications component 606 may carry communications between components on user equipment 102, as well as between user and external devices, such as devices located across a communications network and/or devices serially or locally connected to user equipment 102. For example, communications component 606 may include one or more buses, and may further include transmit chain components and receive chain components associated with a transmitter and receiver, respectively, or a transceiver, operable for interfacing with external devices.

Additionally, user equipment 102 may further include data store 608, which can be any suitable combination of hardware and/or software, that provides for mass storage of information, databases, and programs employed in connection with aspects described herein. For example, data store 608 may be a data repository for applications not currently being executed by processor 104.

User equipment 102 may additionally include a user interface component 610 operable to receive inputs from a user of user equipment 102, and further operable to generate outputs for presentation to the user. User interface component 610 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

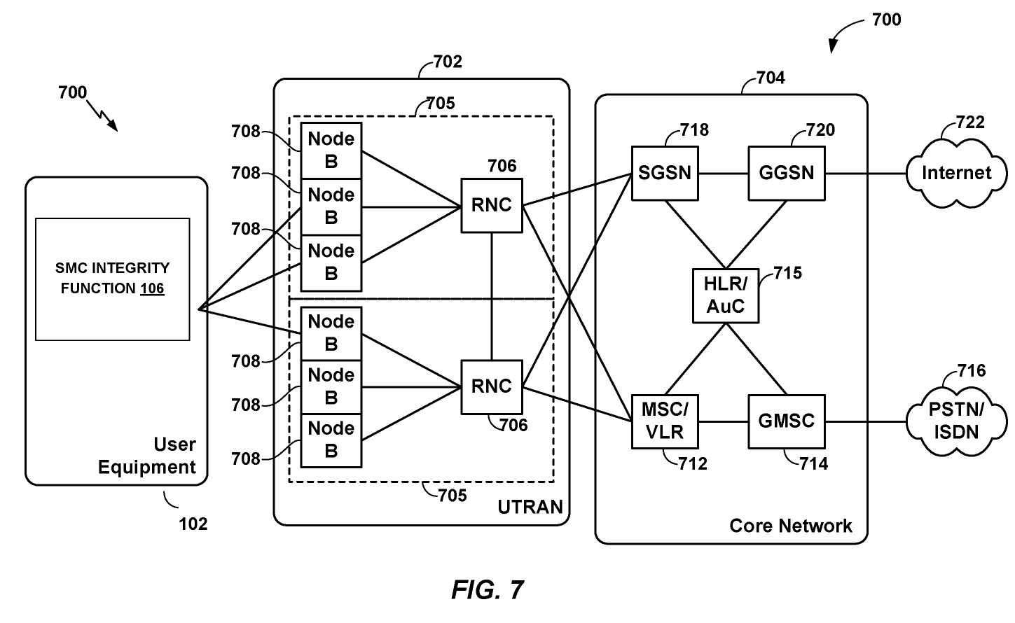

Referring to FIG. 7, by way of example and without limitation, the aspects of the present disclosure are presented with reference to a UMTS system 700 employing a W-CDMA air interface, and may include a UE 102 executing an aspect of SMC integrity function 106 of FIG. 1. A UMTS network includes three interacting domains: a Core Network (CN) 704, a UMTS Terrestrial Radio Access Network (UTRAN) 702, and UE 102. In an aspect, as noted, UE 102 (FIG. 1) may be configured to perform functions thereof, for example, including managing SMC integrity failures at the UE. Further, UTRAN 702 may comprise network entity 120 and/or base station 122 (FIG. 1), which in this case may be respective ones of the Node Bs 708. In this example, UTRAN 702 provides various wireless services including telephony, video, data, messaging, broadcasts, and/or other services. The UTRAN 702 may include a plurality of Radio Network Subsystems (RNSs) such as a RNS 705, each controlled by a respective Radio Network Controller (RNC) such as an RNC 706. Here, the UTRAN 702 may include any number of RNCs 706 and RNSs 705 in addition to the RNCs 706 and RNSs 705 illustrated herein. The RNC 706 is an apparatus responsible for, among other things, assigning, reconfiguring, and releasing radio resources within the RNS 705. The RNC 706 may be interconnected to other RNCs (not shown) in the UTRAN 702 through various types of interfaces such as a direct physical connection, a virtual network, or the like, using any suitable transport network.

Communication between UE 102 and Node B 708 may be considered as including a physical (PHY) layer (e.g., PHY 207) and a medium access control (MAC) layer. Further, communication between UE 102 and RNC 706 by way of a respective Node B 708 may be considered as including a radio resource control (RRC) layer (e.g., Layer 3). In the instant specification, the PHY layer may be considered layer 1; the MAC layer may be considered layer 2; and the RRC layer may be considered layer 3. Information herein below utilizes terminology introduced in the RRC Protocol Specification, 3GPP TS 77.331 v7.1.0, incorporated herein by reference.

The geographic region covered by the RNS 705 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 708 are shown in each RNS 705; however, the RNSs 705 may include any number of wireless Node Bs. The Node Bs 708 provide wireless access points to a CN 704 for any number of mobile apparatuses, such as UE 102, and may be network entity 120 and/or base station 122 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 708. The DL, also called the forward link, refers to the communication link from a Node B 708 to a UE 102 (e.g., link 124), and the UL, also called the reverse link, refers to the communication link from a UE 102 to a Node B 708 (e.g., link 126).

The CN 704 interfaces with one or more access networks, such as the UTRAN 702. As shown, the CN 704 is a GSM core network. However, as those skilled in the art will recognize, the various concepts presented throughout this disclosure may be implemented in a RAN, or other suitable access network, to provide UEs with access to types of CNs other than GSM networks.

The CN 704 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 704 supports circuit-switched services with a MSC 712 and a GMSC 714. In some applications, the GMSC 714 may be referred to as a media gateway (MGW). One or more RNCs, such as the RNC 706, may be connected to the MSC 712. The MSC 712 is an apparatus that controls call setup, call routing, and UE mobility functions. The MSC 712 also includes a VLR that contains subscriber-related information for the duration that a UE is in the coverage area of the MSC 712. The GMSC 714 provides a gateway through the MSC 712 for the UE to access a circuit-switched network 716. The GMSC 714 includes a home location register (HLR) 715 containing subscriber data, such as the data reflecting the details of the services to which a particular user has subscribed. The HLR is also associated with an authentication center (AuC) that contains subscriber-specific authentication data. When a call is received for a particular UE, the GMSC 714 queries the HLR 715 to determine the UE's location and forwards the call to the particular MSC serving that location.

The CN 704 also supports packet-data services with a serving GPRS support node (SGSN) 718 and a gateway GPRS support node (GGSN) 720. GPRS, which stands for General Packet Radio Service, is designed to provide packet-data services at speeds higher than those available with standard circuit-switched data services. The GGSN 720 provides a connection for the UTRAN 702 to a packet-based network 722. The packet-based network 722 may be the Internet, a private data network, or some other suitable packet-based network. The primary function of the GGSN 720 is to provide the UEs 102 with packet-based network connectivity. Data packets may be transferred between the GGSN 720 and the UEs 102 through the SGSN 718, which performs primarily the same functions in the packet-based domain as the MSC 712 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 708 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 708 over the HS-DPCCH to indicate whether it correctly decoded a packet on the downlink.

HS-DPCCH further includes feedback signaling from the UE 102 to assist the Node B 708 in taking the right decision in terms of modulation and coding scheme and precoding weight selection, this feedback signaling including the CQI and PCI.

HSPA Evolved or HSPA+ is an evolution of the HSPA standard that includes MIMO and 74-QAM, enabling increased throughput and higher performance. That is, in an aspect of the disclosure, the Node B 708 and/or the UE 102 may have multiple antennas supporting MIMO technology. The use of MIMO technology enables the Node B 708 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 708 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

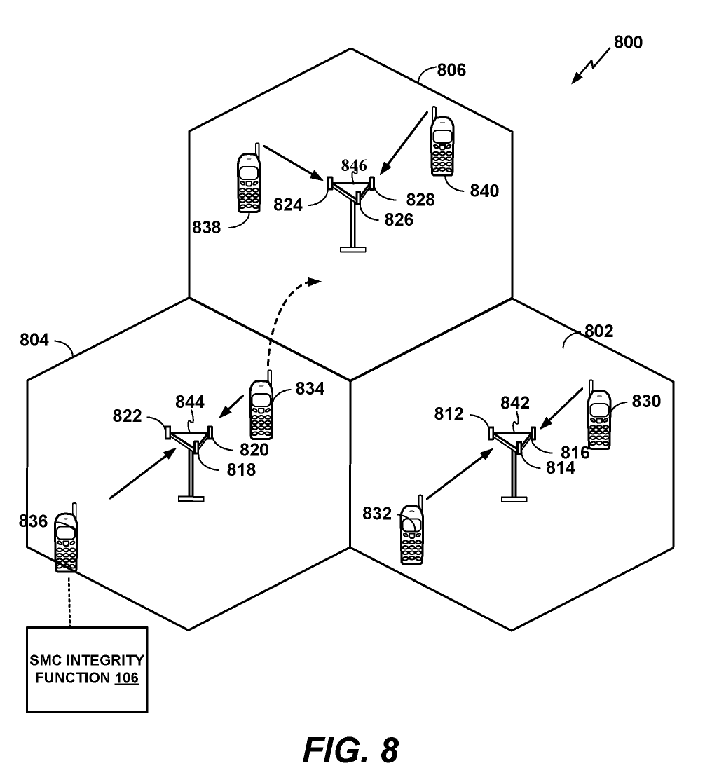

Referring to FIG. 8, an access network 800 in a UTRAN architecture is illustrated, and may include one or more UEs 830, 832, 834, 836, 838, and 840, which may be the same as or similar to UE 102 (FIG. 1) in that they are configured to include SMC integrity function (FIG. 1; for example, illustrated here as being associated with UE 836) for managing SMC integrity failures at the UE. The multiple access wireless communication system includes multiple cellular regions (cells), including cells 802, 804, and 806, each of which may include one or more sectors. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. UEs, for example, 830, 832, etc. may include several wireless communication devices, e.g., User Equipment or UEs, including SMC integrity function 106 of FIG. 1, which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a CN 704 (FIG. 7) for all the UEs 830, 832, 834, 836, 838, 840 in the respective cells 802, 804, and 806. Additionally, each Node B 842, 844, 846 may be base station 122 and/or and UEs 830, 832, 834, 836, 838, 840 may be UE 102 of FIG. 1 and may perform the methods outlined herein.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 706 (FIG. 7), or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set). In any case, UE 834 may perform the reselection operations described herein.

Further, the modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

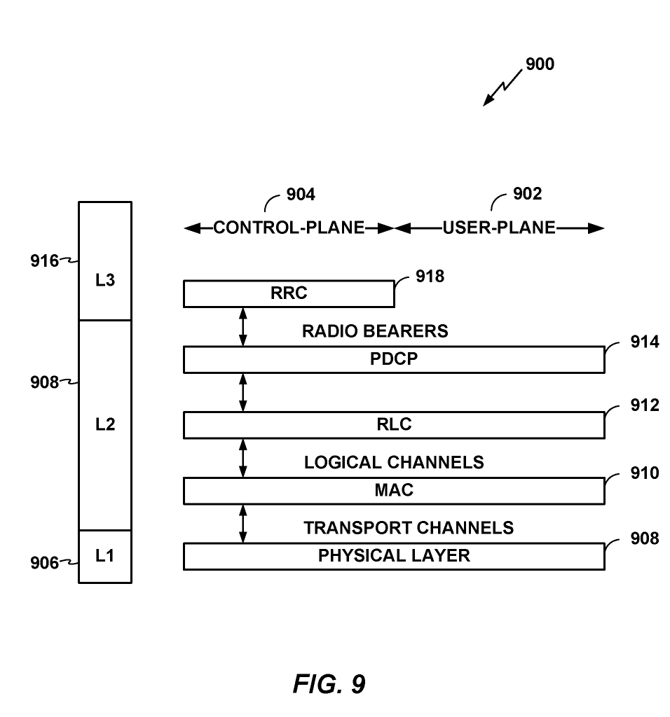

The radio protocol architecture may take on various forms depending on the particular application. An example for an HSPA system will now be presented with reference to FIG. 9. FIG. 9 is a conceptual diagram illustrating an example of the radio protocol architecture for the user plane 902 and control plane 904.

Turning to FIG. 9, the radio protocol architecture for the UE, for example, UE 102 of FIG. 1 configured to include SMC integrity function 106 (FIG. 1) for managing SMC integrity failures at a user equipment (e.g., UE 102) is shown with three layers: Layer 1 (L1), e.g., PHY 906 (FIGS. 2-3), Layer 2 (L2), e.g., RLC/MAC 908 (FIGS. 2-3), and Layer 3 (L3), e.g., RRC 916. Layer 1 is the lowest layer and implements various physical layer signal processing functions. Layer 1 (L1 layer) is referred to herein as the physical layer 906. Layer 2 (L2 layer) 908 is above the physical layer 906 and is responsible for the link between the UE and Node B over the physical layer 906, for example, RLC/MAC 904.

In the user plane, L2 layer 908 includes a media access control (MAC) sublayer 910, a radio link control (RLC) sublayer 912, and a packet data convergence protocol (PDCP) 914 sublayer, which are terminated at the Node B on the network side. Although not shown, the UE may have several upper layers above L2 layer 908 including a network layer (e.g., IP layer) that is terminated at a PDN gateway on the network side, and an application layer that is terminated at the other end of the connection (e.g., far end UE, server, etc.).

The PDCP sublayer 914 provides multiplexing between different radio bearers and logical channels. The PDCP sublayer 914 also provides header compression for upper layer data packets to reduce radio transmission overhead, security by ciphering the data packets, and handover support for UEs between Node Bs. The RLC sublayer 912 provides segmentation and reassembly of upper layer data packets, retransmission of lost data packets, and reordering of data packets to compensate for out-of-order reception due to hybrid automatic repeat request (HARQ). The MAC sublayer 910 provides multiplexing between logical and transport channels. The MAC sublayer 910 is also responsible for allocating the various radio resources (e.g., resource blocks) in one cell among the UEs. The MAC sublayer 910 is also responsible for HARQ operations.

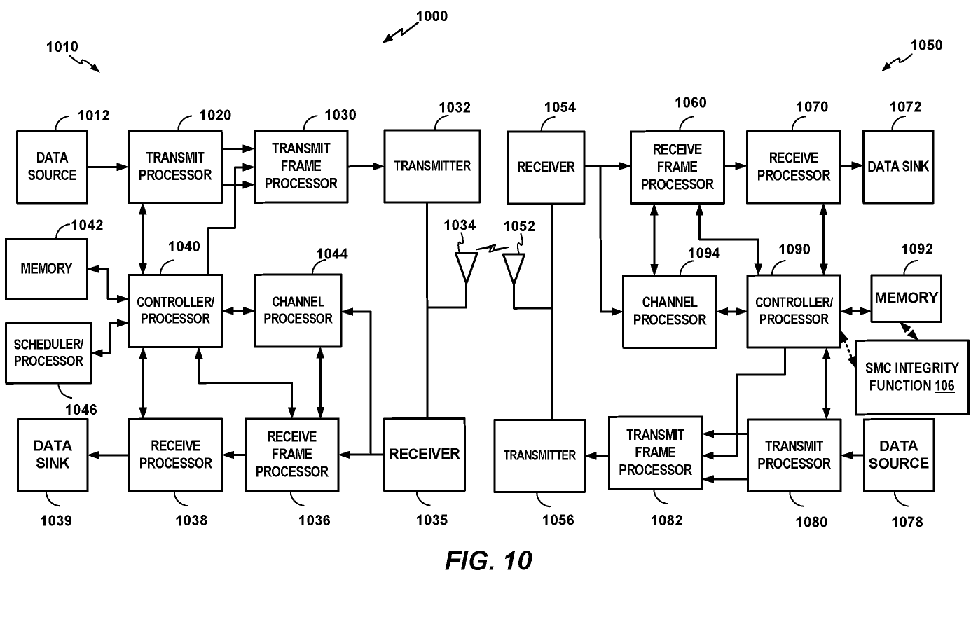

FIG. 10 is a block diagram of a Node B 1010 in communication with a UE 1050, where the Node B 1010 may be base station 122 and/or the UE 1050 may be the same as or similar to UE 102 of FIG. 1 in that it is configured to include SMC integrity function 106 (FIG. 1) for managing SMC integrity failures at the UE, in controller/processor 1090 and/or memory 1092. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and de-spreads the symbols, and then determines the most likely signal constellation points transmitted by the Node B 1010 based on the modulation scheme. These soft decisions may be based on channel estimates computed by the channel processor 1094. The soft decisions are then decoded and de-interleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receive processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer- program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

As used in this application, the terms “function,” “process,” “system” and the like are intended to include a computer-related entity, such as but not limited to hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device can be a process. One or more modules can reside within a module and/or thread of execution and a module may be localized on one computer and/or distributed between two or more computers. In addition, these modules can execute from various computer readable media having various data structures stored thereon. The processes may communicate by way of local and/or remote modules such as in accordance with a signal having one or more data packets, such as data from one module interacting with another module in a local system, distributed system, and/or across a network such as the Internet with other systems by way of the signal.

What is claimed is:

1. A method for managing security mode command (SMC) integrity failures at a user equipment (UE), comprising:
receiving a SMC message at the UE from a network entity;
detecting a message authentication code for data integrity (MAC-I) failure based at least on a mismatch of a security parameter at the UE; and
performing a corrective action at the UE in response to detecting the MAC-I failure at the UE.

2. The method of claim 1, wherein detecting the MAC-I failure based at least on the security parameter includes:
detecting an integrity key (IK) mismatch at the UE.

3. The method of claim 1, wherein performing the corrective action comprises:
triggering a cell update procedure at the UE, wherein the cell update procedure is triggered by setting a T313 timer at the UE to a smaller or zero value.

4. The method of claim 1, wherein performing the corrective action comprises:
skipping a cell update procedure at the UE and transitioning the UE to an idle mode.

5. The method of claim 1, further comprising:
clearing an authentication key at the UE; and
sending a next layer 3 (L3) message to the network entity with a ciphering key sequence number (CKSN) set to a value of seven for triggering a new authentication procedure at the network entity, wherein the L3 message includes a connection management (CM) service request or a paging response.

6. The method of claim 5, further comprising:
retrying of a mobile originated (MO) call silently at the UE when the MO call failed due to a radio resource control (RRC) failure associated with the SMC integrity failure.

7. An apparatus for managing security mode command (SMC) integrity failures at a user equipment (UE), comprising:
means for receiving a SMC message at the UE from a network entity;
means for detecting a message authentication code for data integrity (MAC-I) failure based at least on a mismatch of a security parameter at the UE; and
means for performing a corrective action at the UE in response to detecting the MAC-I failure at the UE.

8. The apparatus of claim 7, wherein the means for detecting the MAC-I failure based at least on the security parameter comprises:
means for detecting an integrity key (IK) mismatch at the UE.

9. The apparatus of claim 7, wherein the means for performing the corrective action comprises:
means for triggering a cell update procedure at the UE, wherein the cell update procedure is triggered by setting a T313 timer at the UE to a smaller or zero value.

10. The apparatus of claim 7, wherein the means for performing the corrective action comprises:
means for skipping a cell update procedure at the UE and transitioning the UE to an idle mode.

11. The apparatus of claim 7, further comprising:
means for clearing authentication key at the UE; and
means for sending a next layer 3 (L3) message to the network entity with a ciphering key sequence number (CKSN) set to a value of seven for triggering a new authentication procedure at the network entity, wherein the L3 message includes a connection management (CM) service request or a paging response.

12. The apparatus of claim 11, further comprising:
means for retrying of a mobile originated (MO) call silently at the UE when the MO call failed due to a radio resource control (RRC) failure associated with the SMC integrity failure.

13. An apparatus for managing security mode command (SMC) integrity failures, comprising:
a memory configured to store data; and
one or more processors communicatively coupled with the memory, wherein the one or more processors and the memory are configured to:
receive a SMC message at the UE from a network entity;
detect a message authentication code for data integrity (MAC-I) failure based at least on a mismatch of a security parameter at the UE; and
perform a corrective action at the UE in response to detecting the MAC-I failure at the UE.

14. The apparatus of claim 13, wherein the one or more processors and the memory are further configured to:
detect an integrity key (IK) mismatch at the UE.

15. The apparatus of claim 13, wherein the one or more processors and the memory are further configured to:
trigger a cell update procedure at the UE, wherein the cell update procedure is triggered by setting a T313 timer at the UE to a smaller or zero value.

16. The apparatus of claim 13, wherein the one or more processors and the memory are further configured to:
skip a cell update procedure at the UE after setting the T313 timer to a smaller value.

17. The apparatus of claim 13, where the one or more processors and the memory are further configured to:
clear an authentication key at the UE; and
send a next layer 3 (L3) message to the network entity with a ciphering key sequence number (CKSN) set to a value of seven for triggering a new authentication procedure at the network entity, wherein the L3 message includes a connection management (CM) service request or a paging response.

18. The apparatus of claim 17, wherein the one or more processors and the memory are further configured to:
retry of a mobile originated (MO) call silently at the UE when the MO call failed due to a radio resource control (RRC) failure associated with the SMC integrity failure.
